(19) United States
(12) Patent Application Publication
(10) Pub. No.: US 2012/0269269 A1
(43) Pub. Date: Oct. 25, 2012

(54) METHOD AND APPARATUS FOR ENCODING AND DECODING MOTION VECTOR OF MULTI-VIEW VIDEO

(75) Inventors: Byeong-doo CHOI, Siheung-si (KR); Dae-sung CHO, Seoul (KR); Seung-soo JEONG, Seoul (KR)

(73) Assignee: Samsung Electronics Co., Ltd., Suwon-si (KR)

(21) Appl. No.: 13/450,911

(22) Filed: Apr. 19, 2012

(30) Foreign Application Priority Data
Apr. 19, 2011 (KR) 10-2011-0036377

(51) Int. Cl. H04N 7/32

(52) U.S. Cl. 375/240.16; 375/E07.123

(57) ABSTRACT

Provided are methods and apparatuses for encoding and decoding a motion vector in a multi-view view image sequence. A method of encoding includes: determining a view direction motion vector of a current block by performing motion prediction on the current block with reference to a first frame having a second view that is different from a first view of the current block; determining view direction motion vector predictor candidates using a view direction motion vector of an adjacent block that refers to a reference frame having a different view from the first view, and a view direction motion vector of a corresponding region included in a second reference frame having the first view and a different picture order count than the current frame; and encoding a difference value between the view direction motion vector of the current block and a selected view direction motion vector predictor, and mode information.

### CROSS-REFERENCE TO RELATED PATENT APPLICATION

This application claims priority from Korean Patent Application No. 10-2011-0036377, filed on Apr. 19, 2011 in the Korean Intellectual Property Office, the disclosure of which is incorporated herein in its entirety by reference.

### BACKGROUND

1. Field

Apparatuses and methods consistent with exemplary embodiments relate to video encoding and decoding, and more particularly, to encoding a multi-view video image by predicting a motion vector of the multi-view video image, and a method and apparatus for decoding the multi-view video image.

2. Description of the Related Art

Multi-view video coding (MVC) involves processing a plurality of images having different views obtained from a plurality of cameras and compression-encoding a multi-view image by using temporal correlation and spatial correlation among inter-views.

In temporal prediction using the temporal correlation and inter-view prediction using the spatial correlation, motion of a current picture is predicted and compensated for in block units by using one or more reference pictures, so as to encode an image. In the temporal prediction and the inter-view prediction, the most similar block to a current block is searched for in a predetermined search range of the reference picture, and when the similar block is searched for, only residual data between the current block and the similar block is transmitted. By doing so, a data compression rate is increased.

In a codec such as MPEG-4 H.264/MPEG-4 advanced video coding (AVC), motion vectors of neighboring blocks, which are adjacent to a current block and are previously encoded, are used to predict a motion vector of the current block. A median value of motion vectors of blocks, which are previously encoded and are adjacent to left, upper and right sides of a current block, is used as a motion vector predictor of the current block.

### SUMMARY

One or more aspects of exemplary embodiments provide a method and apparatus for encoding and decoding a motion vector that is view direction-predicted and is time direction-predicted in multi-view video coding.

According to an aspect of an exemplary embodiment, there is provided a method of encoding a motion vector of a multi-view video, the method including: determining a view direction motion vector of a current block to be encoded by performing motion prediction on the current block by referring to a first frame having a second view that is different from a first view of the current block; generating view direction motion vector predictor candidates by using view direction motion vectors of an adjacent block that refers to a reference frame having a different view from the first view and that are from among adjacent blocks of the current block, and a view direction motion vector of a corresponding region included in a second reference frame having the first view that is the same as the current block and a different picture order count (POC) of the current frame; and encoding a difference value between a view direction motion vector of the current block and a view direction motion vector predictor selected from among the view direction motion vector predictor candidates, and mode information about the view direction motion vector predictor.

According to an aspect of another exemplary embodiment, there is provided a method of encoding a motion vector of a multi-view video, the method including: determining a time direction motion vector of a current block to be encoded by performing motion prediction on the current block by referring to a first frame having a first view that is the same as the current block; generating time direction motion vector predictor candidates by using time direction motion vectors of an adjacent block that refers to a reference frame having the first view and that are from among adjacent blocks of the current block, and a time direction motion vector of a corresponding region included in a second reference frame having a different view from the current block and the same POC as the current block; and encoding a difference value between a time direction motion vector of the current block and a time direction motion vector predictor selected from among the time direction motion vector predictor candidates, and mode information about the time direction motion vector predictor.

According to an aspect of another exemplary embodiment, there is provided a method of decoding a motion vector of a multi-view video, the method including: decoding information about a motion vector predictor of a current block decoded from a bitstream, and a difference value between a motion vector of the current block and a motion vector predictor of the current vector; generating a motion vector predictor of the current block based on the information about the motion vector predictor of the current block; and restoring the motion vector of the current bock based on the motion vector predictor and the difference value, wherein the motion vector predictor is selected from among view direction motion vector predictor candidates that are generated by using view direction motion vectors of an adjacent block that refers to a reference frame having a different view from the first view and that are from among adjacent blocks of the current block, and a view direction motion vector of a corresponding region included in a second reference frame having the first view that is the same as the current block and a different picture order count (POC) of the current frame, according to index information contained in the information about the motion vector predictor.

According to an aspect of another exemplary embodiment, there is provided a method of decoding a motion vector of a multi-view video, the method including: decoding information about a motion vector predictor of a current block decoded from a bitstream, and a difference value between a motion vector of the current block and a motion vector predictor of the current vector; generating a motion vector predictor of the current block based on the information about the motion vector predictor of the current block; and restoring the motion vector of the current bock based on the motion vector predictor and the difference value, wherein the motion vector predictor is selected from among time direction motion vector predictor candidates that are generated by using time direction motion vectors of an adjacent block that refers to a reference frame having the first view and that are from among adjacent blocks of the current block, and a time direction motion vector of a corresponding region included in a second reference frame having a different view from the current block and the same POC as the current block, according to index information contained in the information about the motion vector predictor.

According to an aspect of another exemplary embodiment, there is provided an apparatus for encoding a motion vector of a multi-view video, the apparatus including: a view direction motion prediction unit for determining a view direction motion vector of a current block to be encoded by performing motion prediction on the current block by referring to a first frame having a second view that is different from a first view of the current block; a motion vector encoding unit for generating view direction motion vector predictor candidates by using view direction motion vectors of an adjacent block that refers to a reference frame having a different view from the first view and that are from among adjacent blocks of the current block, and a view direction motion vector of a corresponding region included in a second reference frame having the first view that is the same as the current block and a different picture order count (POC) of the current frame, and for encoding a difference value between a view direction motion vector of the current block and a view direction motion vector predictor selected from among the view direction motion vector predictor candidates, and mode information about the view direction motion vector predictor.

According to an aspect of another exemplary embodiment, there is provided an apparatus for encoding a motion vector of a multi-view video, the apparatus including: a time direction motion prediction unit for determining a time direction motion vector of a current block to be encoded by performing motion prediction on the current block by referring to a first frame having a first view that is the same as the current block; and a motion vector encoding unit for generating time direction motion vector predictor candidates by using time direction motion vectors of an adjacent block that refers to a reference frame having the first view and that are from among adjacent blocks of the current block, and a time direction motion vector of a corresponding region included in a second reference frame having a different view from the current block and the same POC as the current block, and for encoding a difference value between a time direction motion vector of the current block and a time direction motion vector predictor selected from among the time direction motion vector predictor candidates, and mode information about the time direction motion vector predictor.

According to an aspect of another exemplary embodiment, there is provided an apparatus for decoding a motion vector of a multi-view video, the apparatus including: a motion vector decoding unit for decoding information about a motion vector predictor of a current block decoded from a bitstream, and a difference value between a motion vector of the current block and a motion vector predictor of the current vector; a motion compensation unit for generating a motion vector predictor of the current block based on the information about the motion vector predictor of the current block, and for restoring the motion vector of the current bock based on the motion vector predictor and the difference value, wherein the motion vector predictor is selected from among view direction motion vector predictor candidates that are generated by using view direction motion vectors of an adjacent block that refers to a reference frame having a different view from the first view and that are from among adjacent blocks of the current block, and a view direction motion vector of a corresponding region included in a second reference frame having the first view that is the same as the current block and a different picture order count (POC) of the current frame, according to index information contained in the information about the motion vector predictor.

According to an aspect of another exemplary embodiment, there is provided an apparatus for decoding a motion vector of a multi-view video, the apparatus including: a motion vector decoding unit for decoding information about a motion vector predictor of a current block decoded from a bitstream, and a difference value between a motion vector of the current block and a motion vector predictor of the current vector; and a motion compensation unit for generating a motion vector predictor of the current block based on the information about the motion vector predictor of the current block, and restoring the motion vector of the current bock based on the motion vector predictor and the difference value, wherein the motion vector predictor is selected from among time direction motion vector predictor candidates that are generated by using time direction motion vectors of an adjacent block that refers to a reference frame having the first view and that are from among adjacent blocks of the current block, and a time direction motion vector of a corresponding region included in a second reference frame having a different view from the current block and the same POC as the current block, according to index information contained in the information about the motion vector predictor.

Accordingly, a motion vector of a multi-view video may be effectively encoded, thereby increasing a compression rate of a multi-view video.

### BRIEF DESCRIPTION OF THE DRAWINGS

The above and other features and advantages will become more apparent by describing in detail exemplary embodiments with reference to the attached drawings in which:

FIG. 1 is a diagram illustrating a multi-view video sequence encoded by using a method of encoding and decoding a multi-view video according to an exemplary embodiment;

FIG. 2 is a block diagram illustrating a configuration of a multi-view video encoding apparatus according to an exemplary embodiment;

FIG. 3 is a block diagram of a motion prediction unit that corresponds to a motion prediction unit of FIG. 2, according to an exemplary embodiment;

FIG. 4 is a reference view for describing a process of generating a view direction motion vector and a time direction motion vector, according to an exemplary embodiment;

FIG. 5 is a reference diagram for describing a prediction process of a motion vector, according to an exemplary embodiment;

FIG. 6 is a reference diagram for describing a process of generating a view direction motion vector predictor, according to another exemplary embodiment;

FIG. 7 is a reference diagram for describing a process of generating a time direction motion vector predictor, according to another exemplary embodiment;

FIG. 8 is a flowchart of a process of encoding a view direction motion vector, according to an exemplary embodiment;

FIG. 9 is a flowchart of a process of encoding a time direction motion vector, according to an exemplary embodiment;

FIG. 10 is a block diagram of a multi-view video encoding apparatus according to an exemplary embodiment; and

FIG. 11 is a flowchart of a method of decoding a video, according to an exemplary embodiment.

### DETAILED DESCRIPTION OF EXEMPLARY EMBODIMENTS

Hereinafter, exemplary embodiments will be described in detail with reference to the attached drawings.

Throughout this specification, the terminology “view direction motion vector” refers to a motion vector of a motion block that is prediction-encoded by using a reference frame contained in a different view. In addition, the terminology “time direction motion vector” refers to a motion vector of a motion block that is prediction-encoded by using a reference frame contained in the same view.

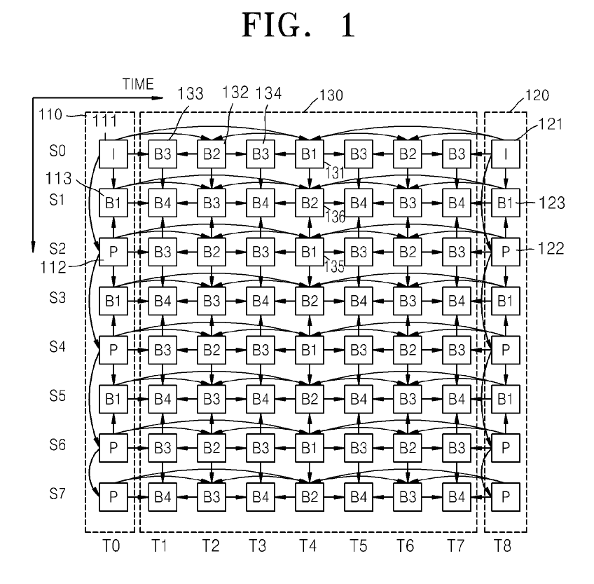

FIG. 1 is a diagram illustrating a multi-view video sequence encoded by using a method of encoding and decoding a multi-view video according to an exemplary embodiment.

Referring to FIG. 1, an X-axis is a time axis, and a Y-axis is a view axis. T0 through T8 of the X-axis indicate sampling times of an image, respectively, and S0 through S8 of the Y-axis indicate different views, respectively. In FIG. 1, each row indicates each image picture group that is input having the same view, and each column indicates multi-view images at the same time.

In multi-view image encoding, an intra-picture is periodically generated with respect to an image having a base view, and other pictures are prediction-encoded by performing temporal prediction or inter-view prediction based on generated intra pictures.

The temporal prediction uses the same view, i.e., temporal correlation between images of the same row in FIG. 1. For the temporal prediction, a prediction structure using a hierarchical B-picture may be used. The inter-view prediction uses the same time, i.e., spatial correlation between images of the same column. Hereinafter, a case of encoding image picture groups by using the hierarchical B-picture will be described. However, the method of encoding and decoding a multi-view video, according to the present exemplary embodiment, may be applied to another multi-view video sequence having a different structure other than a hierarchical B-picture structure in one or more other exemplary embodiments.

In order to perform prediction by using the same view, i.e., temporal correlation between images of the same row, a multi-view picture prediction structure using the hierarchical B-picture prediction-encodes an image picture group having the same view into bi-directional pictures (hereinafter, referred to as “B-pictures”) by using anchor pictures. Here, the anchor pictures indicate pictures included in columns 110 and 120 among the columns of FIG. 1, wherein the columns 110 and 120 are respectively at a first time T0 and a last time T8 and include intra-pictures. Except for the intra-pictures (hereinafter, referred to as “I-pictures”), the anchor pictures are prediction-encoded by using only inter-view prediction. Pictures that are included in the rest of the columns 130 other than the columns 110 and 120 including the I-pictures are referred to as non-anchor pictures.

Hereinafter, a description will be provided for an example in which image pictures that are input for a predetermined time period having a first view S0 are encoded by using a hierarchical B-picture. From among the image pictures input having the first view S0, a picture 111 input at the first time T0 and a picture 121 input at the last time T8 are encoded as I-pictures. Next, a picture 131 input at a Time T4 is bi-directionally prediction-encoded by referring to the I-pictures 111 and 121 that are anchor pictures, and then is encoded as a B-picture. A picture 132 input at a Time T2 is bi-directionally prediction-encoded by using the I-picture 111 and the B-picture 131, and then is encoded as a B-picture. Similarly, a picture 133 input at a Time T1 is bi-directionally prediction-encoded by using the I-picture 111 and the B-picture 132, and a picture 134 input at a Time T3 is bi-directionally prediction-encoded by using the B-picture 132 and the B-picture 131. In this manner, since image sequences having the same view are bi-directionally prediction-encoded in a hierarchical manner by using anchor pictures, the image sequences encoded by using this prediction-encoding method are called hierarchical B-pictures. In Bn (where n=1, 2, 3, and 4) of FIG. 1, n indicates a B-picture that is nth bi-directionally predicted. For example, B1 indicates a picture that is first bi-directionally predicted by using an anchor picture that is an I-picture or a P-picture. B2 indicates a picture that is bi-directionally predicted after the B1 picture, B3 indicates a picture that is bi-directionally predicted after the B2 picture, and B4 indicates a picture that is bi-directionally predicted after the B3 picture.

When the multi-view video sequence is encoded, an image picture group having the first view S0 that is a base view may be encoded by using the hierarchical B-picture. In order to encode image sequences having other views, first, by performing inter-view prediction using the I-pictures 111 and 121 having the first view S0, image pictures having odd views S2, S4, and S6, and an image picture having a last view S7 that are included in the anchor pictures 110 and 120 are prediction-encoded as P-pictures. Image pictures having even views 51, S3, and S5 included in the anchor pictures 110 and 120 are bi-directionally predicted by using an image picture having an adjacent view according to inter-view prediction, and are encoded as B-pictures. For example, the B-picture 113 that is input at a Time T0 having a second view S1 is bi-directionally predicted by using the I-picture 111 and a P-picture 112 having adjacent views S0 and S2.

When each of image pictures having all views and included in the anchor pictures 110 and 120 is encoded as any one of IBP-pictures, as described above, the non-anchor pictures 130 are bi-directionally prediction-encoded by performing temporal prediction and inter-view prediction that use the hierarchical B-picture.

From among the non-anchor pictures 130, image pictures having the odd views S2, S4, and S6, and an image picture having the last view S7 are bi-directionally prediction-encoded by using anchor pictures having the same view according to temporal prediction using the hierarchical B-picture. From among the non-anchor pictures 130, image pictures having even views S1, S3, S5, and S7 are bi-directionally predicted by performing not only temporal prediction using the hierarchical B-picture but also performing inter-view prediction using pictures having adjacent views. For example, a picture 136 that is input at a Time T4 having the second view S1 is predicted by using anchor pictures 113 and 123, and pictures 131 and 135 having adjacent views.

As described above, the P-pictures that are included in the anchor pictures 110 and 120 are prediction-encoded by using an I-picture having a different view and input at the same time, or a previous P-picture. For example, a P-picture 122 that is input at a Time T8 at a third view S2 is prediction-encoded by using an I-picture 121 as a reference picture, wherein the I-picture 121 is input at the same time at a first view S0.

In the multi-view video sequence of FIG. 1, a P-picture or a B-picture is prediction-encoded by using a picture having a different view from a reference picture, wherein the picture is input at the same time, or is prediction-encoded by using a picture having the same view as a reference picture, wherein the picture is input at different points of time. That is, when a block contained in the P-picture or the B-picture is encoded by using a picture having a different view and input at the same time as a reference picture, a view direction motion vector may be obtained. When a block contained in the P-picture or the B-picture is encoded by using a picture having the same view and input at different points of time as a reference picture, a time direction motion vector may be obtained. In general, in order to encode a single-view video, instead of encoding motion vector information of a current block, a motion vector predictor is predicted by using a median value of motion vectors of blocks adjacent to upper, left and right sides of a current block, and then a difference value between the motion vector predictor and an actual motion vector is encoded as motion vector information. However, in multi-view image encoding, since a view direction motion vector and a time direction motion vector may coexist in adjacent blocks, when a median value of motion vectors of adjacent blocks is used as a motion vector predictor of a current block, like in a related art method, a type of a motion vector of the current block may not be identical to a type of motion vectors of adjacent blocks that are used to determine a motion vector predictor. Thus, the present exemplary embodiment provides a method of encoding and decoding a motion vector for efficiently predicting a motion vector of a current block in order to perform multi-view image encoding, so that a compression rate of a multi-view video is increased.

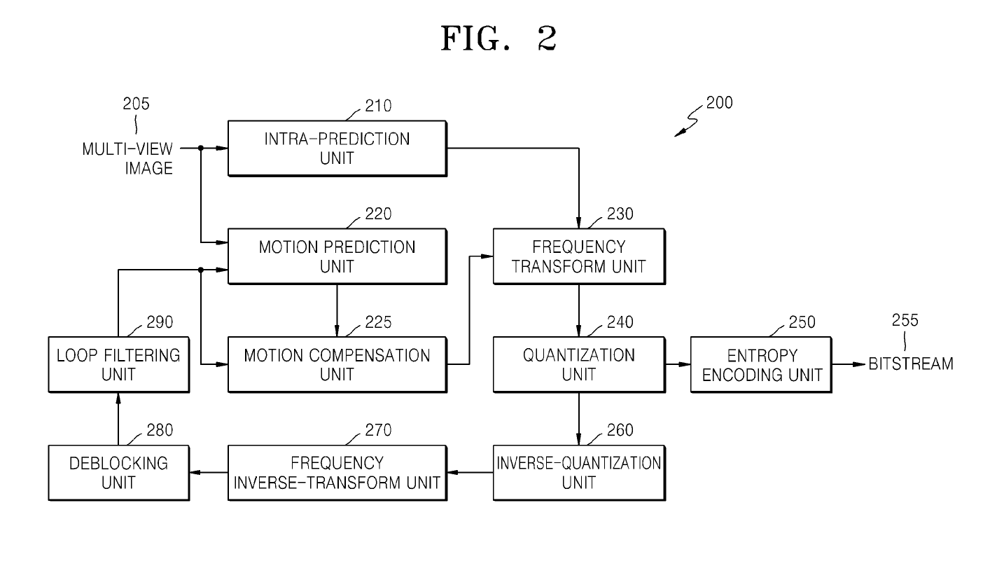

FIG. 2 is a block diagram illustrating a configuration of a multi-view video encoding apparatus 200 according to an exemplary embodiment.

Referring to FIG. 2, the multi-view video encoding apparatus 200 includes an intra-prediction unit 210, a motion prediction unit 220, a motion compensation unit 225, a frequency transform unit 230, a quantization unit 240, an entropy encoding unit 250, an inverse-quantization unit 260, a frequency inverse-transform unit 270, a deblocking unit 280, and a loop filtering unit 290.

The intra-prediction unit 210 performs intra-prediction on blocks that are encoded as I-pictures in anchor pictures among a multi-view image, and the motion prediction unit 220 and the motion compensation unit 225 perform motion prediction and motion compensation, respectively, by referring to a reference frame that is included in an image sequence having the same view as an encoded current block and that has a different picture order count (POC), or by referring to a reference frame having a different view from the current block and having the same POC as the current block.

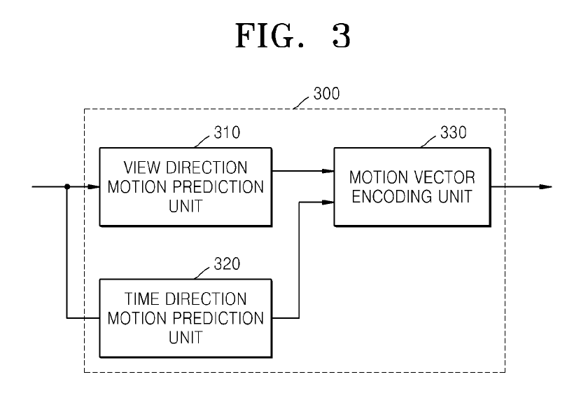

FIG. 3 is a block diagram of a motion prediction unit 300 that corresponds to the motion prediction unit 220 of FIG. 2, according to an exemplary embodiment.

Referring to FIG. 3, the motion prediction unit 300 includes a view direction motion prediction unit 310, a time direction motion prediction unit 320, and a motion vector encoding unit 330.

The view direction motion prediction unit 310 determines a view direction motion vector of a current block by performing motion prediction on a current block by referring to a first reference frame having a second view that is different from a first view of the current block to be encoded. When the current block is predicted by referring to a reference frame having a different view, the motion vector encoding unit 330 generates view direction motion vector predictor candidates by using view direction motion vectors of adjacent blocks that refer to a reference frame having a different view and that are from among adjacent blocks of the current block, and a view direction motion vector of a corresponding region included in a reference frame having a different picture order count (POC) from a POC of a current frame and having the same view as the current block, and encodes a difference value between a view direction motion vector predictor selected from among the view direction motion vector predictor candidates and the view direction motion vector of the current block, and mode information about the selected view direction motion vector predictor.

The time direction motion prediction unit 320 determines a time direction motion vector of the current block by performing motion prediction on the current block by referring to the first frame having the first view that is the same as the first view of the current block to be encoded. When the current block is predicted by referring to a reference frame having a different POC and having the same view of the current block, the motion vector encoding unit 330 generates time direction motion vector predictor candidates by using time direction motion vectors of adjacent blocks that refer to a reference frame having the same view and that are from among adjacent blocks of the current block, and a time direction motion vector of a corresponding region included in a reference frame having a different view from the current block and the same POC as the current frame, and encodes a difference value between a time direction motion vector predictor selected from among the time direction motion vector predictor candidate and the time direction motion vector of the current block, and mode information about the selected time direction motion vector predictor. A controller (not shown) may determine a motion vector to be applied to the current block by comparing rate-distortion (R-D) costs according to a motion vector of the view direction motion vector and a motion vector of the time direction motion vector.

Referring back to FIG. 2, data output from the intra-prediction unit 210, the motion prediction unit 220, and the motion compensation unit 225 passes through the frequency transform unit 230 and the quantization unit 240 and then is output as a quantized transform coefficient. The quantized transform coefficient is restored as data in a spatial domain by the inverse-quantization unit 260 and the frequency inverse-transform unit 270, and the restored data in the spatial domain is post-processed by the deblocking unit 280 and the loop filtering unit 290 and then is output as a reference frame 295. Here, the reference frame 295 may be an image sequence having a specific view and being previously encoded, compared to an image sequence having a different view in a multi-view image sequence. For example, an image sequence including an anchor picture and having a specific view is previously encoded compared to an image sequence having a different view, and is used as a reference picture when the image sequence having the different view is prediction-encoded in a view direction. The quantized transform coefficient may be output as a bitstream 255 by the entropy encoding unit 250.

Hereinafter, a detailed description is provided with respect to a process of generating a view direction motion vector and a time direction motion vector, according to an exemplary embodiment.

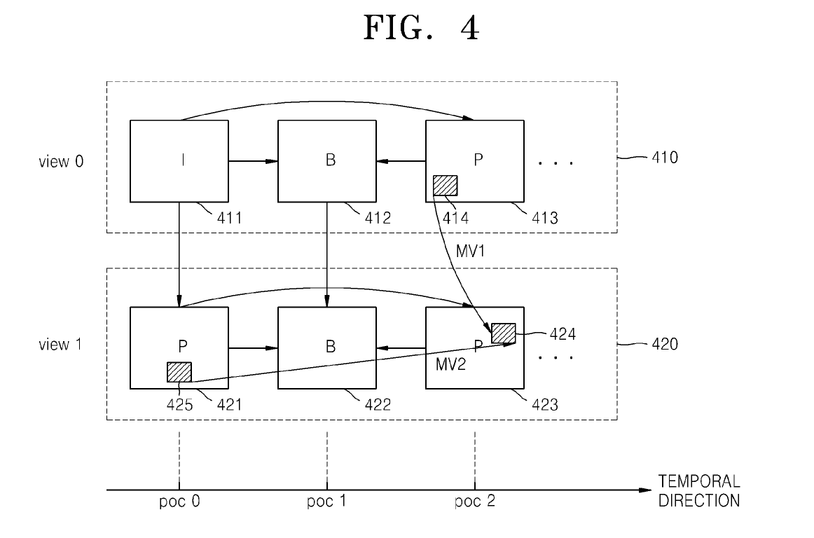

FIG. 4 is a reference view for describing a process of generating a view direction motion vector and a time direction motion vector, according to an exemplary embodiment.

Referring to FIGS. 2 and 4, the multi-view video encoding apparatus 200 performs prediction-encoding on frames 411, 412, and 413 included in an image sequence 410 having a second view (view 0), and then restores the frames 411, 412, and 413 included in the image sequence 410 having the second view (view 0) which is encoded to be used as a reference frame for prediction-encoding of an image sequence having a different view. That is, the frames 411, 412, and 413 included in the image sequence 410 having the second view (view 0) are encoded and then restored before an image sequence 420 having a first view (view 1). As shown in FIG. 4, the frames 411, 412, and 413 included in the image sequence 410 having the second view (view 0) may be frames that are prediction-encoded in a temporal direction by referring to other frames included in the image sequence 410, or may be frames that are previously encoded by referring to an image sequence having a different view (not shown) and then are restored. In FIG. 4, an arrow denotes a prediction direction indicating which reference frame is referred so as to predict each frame. For example, a P frame 423 having the first view (view 1) and including a current block 424 to be encoded may be prediction-encoded by referring to another P frame 421 having the same view or may be prediction-encoded by referring to the P frame 413 having the second view (view 0) and the same POC 2. That is, as shown in FIG. 4, the current block 424 may have a view direction motion vector MV1 indicating a corresponding region 414 that is searched for as the most similar region to the current block 424 in the P frame 413 having the second view (view 0) and the same POC 2, and a time direction motion vector MV2 indicating a corresponding region 425 that is searched for as the most similar region to the current block 424 in the P frame 421 having the first view (view 1) and different POC 0. In order to determine a final motion vector of the current block 424, R-D costs according to the view direction motion vector (MV1) and the time direction motion vector (MV2) are compared, and then a motion vector having a smaller R-D cost is determined as the final motion vector of the current 424.

When the motion prediction unit 220 determines the view direction motion vector (MV1) or the time direction motion vector (MV2) of the current block 424, the motion compensation unit 225 determines the corresponding region 414 indicated by the view direction motion vector (MV1) or the corresponding region 425 indicated by the time direction motion vector (MV2) as a prediction value of the current block 424.

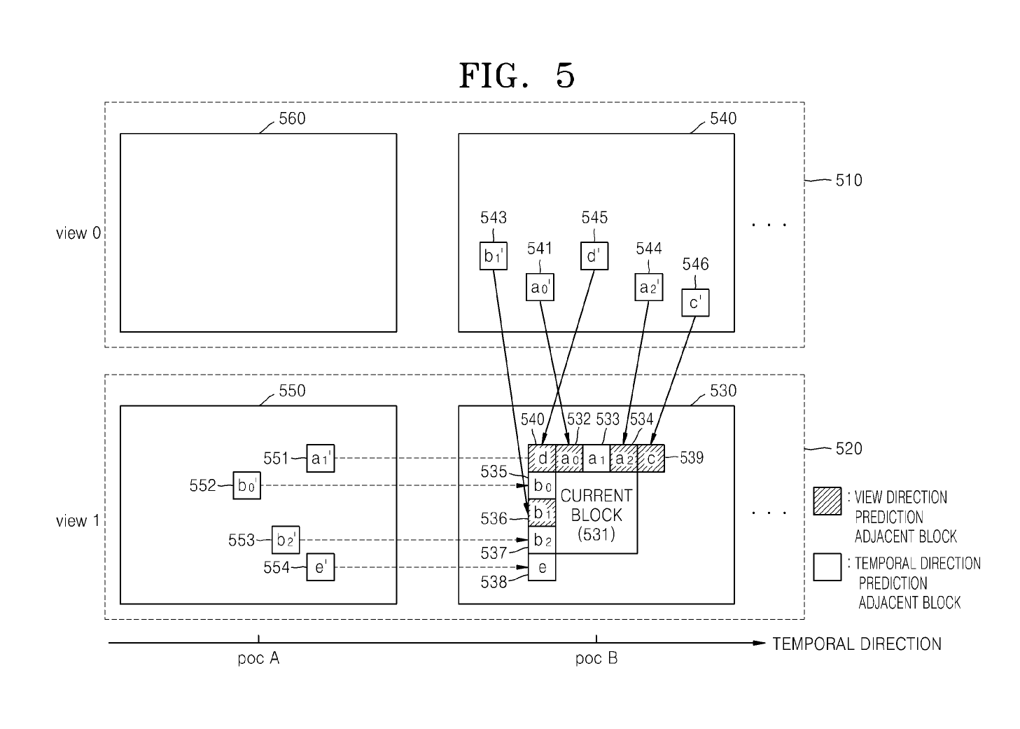

FIG. 5 is a reference diagram for describing a prediction process of a motion vector, according to an exemplary embodiment.

Referring to FIG. 5, it is assumed that frames 540 and 560 included in an image sequence 510 having a second view (view 0) are encoded and then restored before an image sequence 520 having a first view (view 1), and that a frame 530 including a current block 531 to be encoded has a POC ‘B’. In addition, as shown in FIG. 5, it is assumed that blocks ao 532, a2 534, b1 536, c 539, and d 540 from among adjacent blocks 532 through 540 of the current block 531 are adjacent blocks that are view direction-predicted by respectively referring to blocks ao′ 541, a2′ 544, b1′ 543, c′ 546, and d′ 545 that have the same POC ‘B’ and are corresponding regions of a frame 540 having a different view (view 0) from the frame 530 including the current block 531. In addition, it is assumed that blocks a1 533, bo 535, b2 537, and e 538 are adjacent blocks that are time direction predicted by respectively referring to blocks a1′ 551, bo′ 552, b2′ 553, and e′ 554 that are corresponding regions of a frame 550 included in the image sequence 520 having the same view as the current block 531 and having different POC ‘A’ from the current block 531 in the image sequence 520.

When the current block 531 is predicted by referring to the reference frame 540 having the second view (view 0) that is different from the first view (view 1), the motion vector encoding unit 330 may generate view direction motion vector predictor candidates by using view direction motion vectors of adjacent blocks, that is, blocks ao 532, a2 534, b1 536, c 539, and d 540 that refer to the reference frame 540 having the second view (view 0) and that are from among the adjacent blocks 532 through 540 of the current block 531. In detail, the motion vector encoding unit 330 selects a motion vector of a block b1 that is initially scanned, that refers to the reference frame 540 having the second view (view 0), and that are from among blocks b0 through b2 that are adjacent to a left side of the current block 531, as a first view direction motion vector predictor. The motion vector encoding unit 330 selects a motion vector of a block a0 that is initially scanned, that refers to the reference frame 540 having the second view (view 0), and that are from among blocks a0 through a2 that are adjacent to an upper side of the current block 531, as a second view direction motion vector predictor. In addition, the motion vector encoding unit 330 selects a motion vector of a bock d that is initially scanned, refers to the reference frame 540 having the second view (view 0), and that are from among blocks c, d, and e that are adjacent to a corner of the current block 531, as a third view direction motion vector predictor. In addition, the motion vector encoding unit 330 adds a median value of the first view direction motion vector predictor, the second view direction motion vector predictor, and the third view direction motion vector predictor, to a view direction motion vector predictor candidate. In this case, the motion vector encoding unit 330 may set a motion vector predictor that does not correspond to any one of the first view direction motion vector predictor, the second view direction motion vector predictor, and the third view direction motion vector predictor, as a 0 vector, and then may determine a median value.

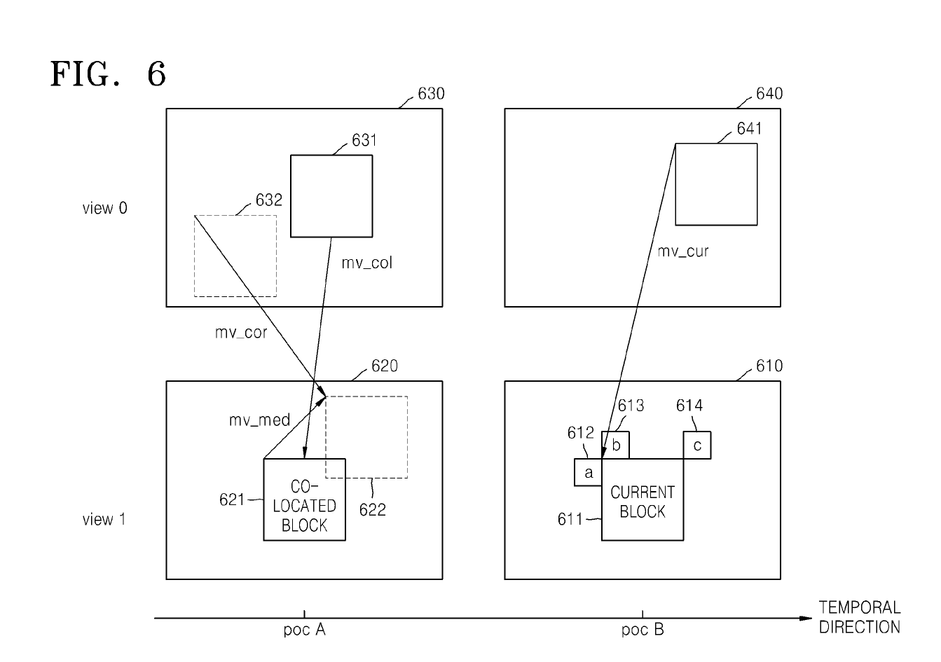

FIG. 6 is a reference diagram for describing a process of generating a view direction motion vector predictor, according to another exemplary embodiment.

According to another exemplary embodiment, the motion vector encoding unit 330 may add a view direction motion vector of a co-located block of a current block, which is included in a reference frame having the same view and different POC of the current block, and a view direction motion vector of a corresponding block that is obtained by shifting the co-located block by using a time direction motion vector of adjacent blocks of the current block, to a view direction motion vector predictor candidate.

Referring to FIG. 6, it is assumed that a co-located block 621 of a frame 620 having the same view (view 1) as a current block 611 and a POC ‘A’ that is different from a POC ‘B’ of the current block 610 is a view direction-predicted block referring to a region 621 of a frame 630 having a different view (view 0), and has a view direction motion vector mv_col. In this case, the motion vector encoding unit 330 may determine the view direction motion vector my col of the co-located block 621 as a view direction motion vector predictor candidate of the current block 611. Also, the motion vector encoding unit 330 may shift the co-located block 621 by using a time direction motion vector of an adjacent block that refers to the frames 620 and that is from among adjacent blocks of the current block 611, and may determine a view direction motion vector mv_cor of the shifted corresponding block 622 as a view direction motion vector predictor candidate of the current block 611. For example, when it is assumed that adjacent blocks a 612, b 613, and c 614 of the current block 611 are view direction-predicted adjacent blocks referring to the frame 620, the motion vector encoding unit 330 may calculate a median value mv_med of the adjacent blocks a 612, b 613, and c 614, and may determine the shifted corresponding block 622 by shifting the co-located block 621 as much as the median value mv_med. Then, the motion vector encoding unit 330 may determine the view direction motion vector mv_cor of the shifted corresponding block 622 as a view direction motion vector predictor candidate of the current block 611.

Referring back to FIG. 5, when the current block 531 is predicted by referring to the reference frame 550 having the same view (View 1) and a different POC, the motion vector encoding unit 330 may generate time direction motion vector predictor candidates by using time direction motion vectors of adjacent blocks a1 533, b0 535, b2 537, and e 538 that refer to the reference frame 550 having the same view (view 1) and a different POC and that are from among the adjacent blocks 532 through 540 of the current block 531. In detail, the motion vector encoding unit 330 selects a motion vector of a block b0 that is initially scanned, that refers to the reference frame 550 having the same view (view 1) and a different POC, and that are from among blocks b0 trough b2 that are adjacent to a left side of the current block 531, as a first time direction motion vector predictor. The motion vector encoding unit 330 selects a motion vector of a block a1 that is initially scanned, that refers to the reference frame 550 having the same view (view 1) and a different POC, and are from among blocks a0 through a2 that are adjacent to an upper side of the current block 531, as a second time direction motion vector predictor. In addition, the motion vector encoding unit 330 selects a motion vector of a block e that is initially scanned, that refers to the reference frame 550 having the same view (view 1) and a different POC, and that are from among blocks c, d, and e that are adjacent to a corner of the current block 531, as a third time direction motion vector predictor. The motion vector encoding unit 330 adds a median value of the first time direction motion vector predictor, the second time direction motion vector predictor, and the third time direction motion vector predictor, to a time direction motion vector predictor candidate. In this case, the motion vector encoding unit 330 may set a motion vector predictor that does not correspond to any one of the first time direction motion vector predictor, the second time direction motion vector predictor, and the third time direction motion vector predictor, as a 0 vector, and then may determine a median value. In the above-described exemplary embodiments, a case where a block has the same reference frame as a current block from among adjacent blocks has been described. However, when a time direction motion vector predictor is generated in one or more other exemplary embodiments, the time direction motion vector predictor of the current block may be determined by scaling a time direction motion vector of an adjacent block referring to a reference frame that is different from a reference frame of the current frame and has the same view as the current frame.

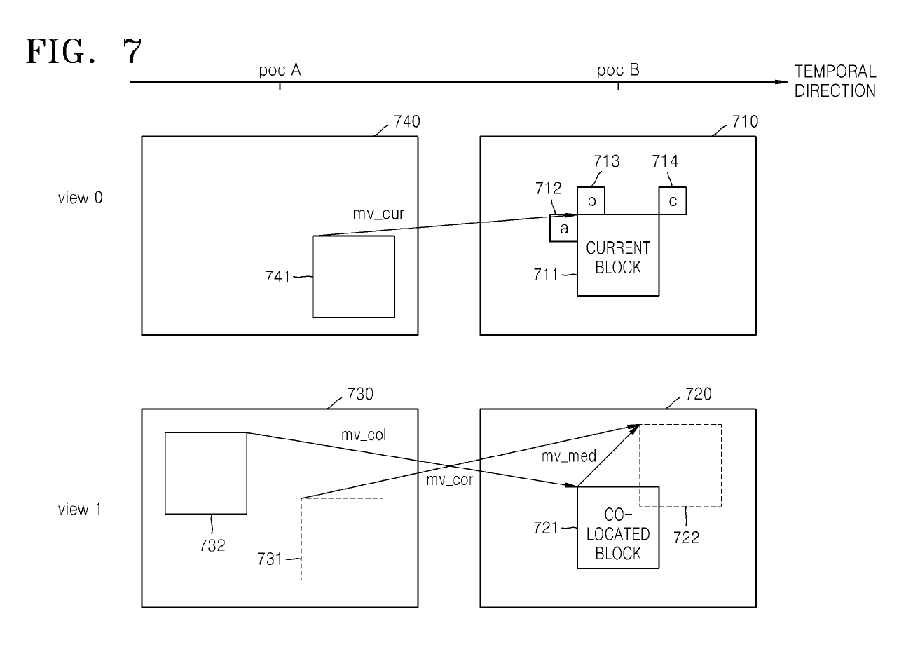

FIG. 7 is a reference diagram for describing a process of generating a time direction motion vector predictor, according to another exemplary embodiment.

According to another exemplary embodiment, the motion vector encoding unit 330 may add a time direction motion vector of a co-located block of a current block, which is included in a reference frame having the same POC and a different view from the current block, and a time direction motion vector of a corresponding block that is obtained by shifting the co-located block by using a view direction motion vector of adjacent blocks of the current block, to a time direction motion vector predictor candidate.

Referring to FIG. 7, it is assumed that a co-located block 721 of a frame 720 having a different view 1 of a current block 711 and the same POC B of the current frame 710 is a time direction-predicted block referring to a region 732 of a frame 730 having a different POC A, and has a time direction motion vector my col. In this case, the motion vector encoding unit 330 may determine the time direction motion vector my col of the co-located block 721 as a time direction motion vector predictor candidate of the current block 711. Also, the motion vector encoding unit 330 may shift the co-located block 721 by using a view direction motion vector of an adjacent block that refers to the frame 720 and that is from among adjacent blocks of the current block 711, and may determine a time direction motion vector mv_cor of the shifted corresponding block 722 as a time direction motion vector predictor candidate of the current block 711. For example, when it is assumed that adjacent blocks a 712, b 713, and c 714 of the current block 711 are time direction-predicted adjacent blocks referring to the frame 720, the motion vector encoding unit 330 may calculate a median value of the adjacent blocks a 712, b 713, and c 714, and may determine the shifted corresponding block 722 by shifting the co-located block 721 as much as the median value mv_med. Then, the motion vector encoding unit 330 may determine the time direction motion vector mv_cor of the shifted corresponding block 722 as a time direction motion vector predictor candidate of the current block 711.

Like in FIGS. 5 through 7, if a view direction motion vector predictor candidate or a time direction motion vector predictor candidate of a current block is generated by using various methods, the multi-view video encoding apparatus 200 may compare costs according to a motion vector of the current block and a motion vector predictor candidate by using a difference value between the motion vector of the current block and the motion vector predictor candidate, may determine a motion vector predictor that is the most similar to the motion vector of the current block, that is, a motion vector predictor having a smallest cost, and may encode only the difference value between the motion vector of the current block and the motion vector predictor as motion vector information of the current block. In this case, the multi-view video encoding apparatus 200 may differentiate view direction motion vector predictor candidates and time direction motion vector predictor candidates according to a predetermined index, and may add index information corresponding to a motion vector predictor used in the motion vector of the current vector, as information about a motion vector, to an encoded bitstream.

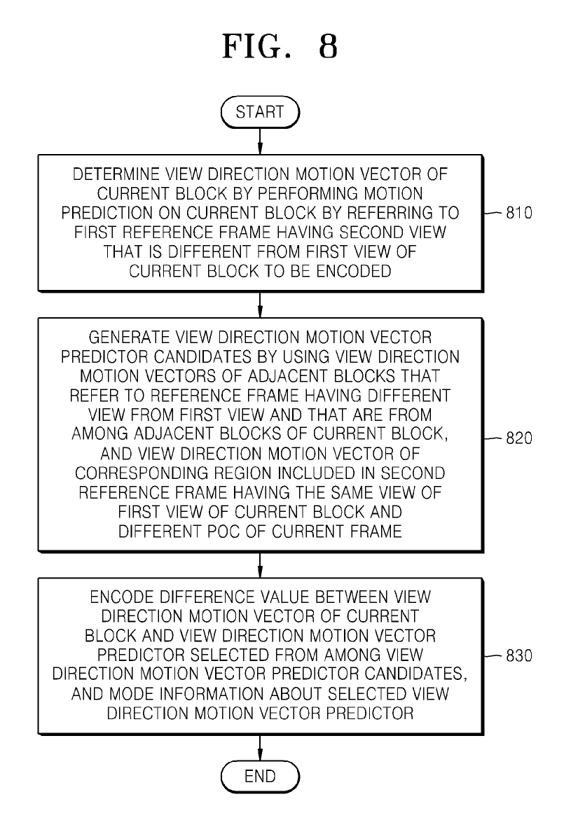

FIG. 8 is a flowchart of a process of encoding a view direction motion vector, according to an exemplary embodiment.

Referring to FIG. 8, in operation 810, the view direction motion prediction unit 310 determines a view direction motion vector of a current block by performing motion prediction on a current block by referring to a first reference frame having a second view that is different from a first view of the current block to be encoded.

In operation 820, the motion vector encoding unit 330 generates view direction motion vector predictor candidates by using view direction motion vectors of adjacent blocks that refer to a reference frame having a different view from the first view and that are from among adjacent blocks of the current block, and a view direction motion vector of a corresponding region included in a second reference frame having the same view as the first view of the current block and a different POC of a current frame. As described above, the view direction motion vector predictor candidates may further include the first view direction motion vector predictor that is selected from among view direction motion vectors of blocks that are adjacent to a left side of the current block referring to a reference frame having a different view, a second view direction motion vector predictor that is selected from among view direction motion vectors of blocks that are adjacent to an upper side of the current block, and a third view direction motion vector predictor that is selected from among view direction motion vectors of blocks that are adjacent to vertexes of the current block and are encoded before the current block. In addition, the view direction motion vector predictor candidates may further include a median value of the first view direction motion vector predictor, the second view direction motion vector predictor, and the third view direction motion vector predictor. In addition, the view direction motion vector predictor candidate may include a view direction motion vector of a corresponding block obtained by shifting a co-located block of the current block, which is included in the second reference frame, by using a time direction motion vector of adjacent blocks of the current blocks.

In operation 830, the motion vector encoding unit 330 encodes a difference value between a view direction motion vector of the current block and a view direction motion vector predictor selected from among view direction motion vector predictor candidates, and mode information about the selected view direction motion vector predictor.

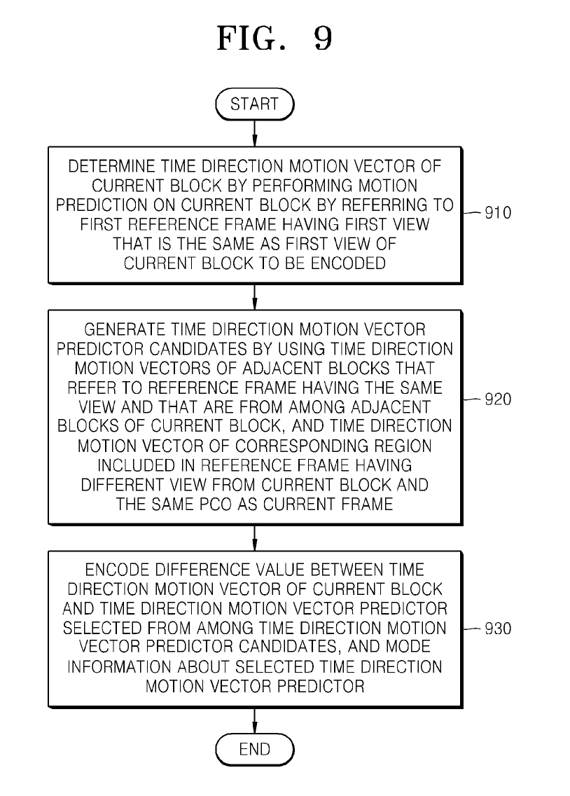

FIG. 9 is a flowchart of a process of encoding a time direction motion vector, according to an exemplary embodiment.

Referring to FIG. 9, in operation 910, the time direction motion prediction unit 320 determines a time direction motion vector of a current block by performing motion prediction on the current block by referring to a first reference frame having a first view that is the same as the first view of the current block to be encoded.

In operation 920, the motion vector encoding unit 330 generates time direction motion vector predictor candidates by using time direction motion vectors of adjacent blocks that refer to a reference frame having the same view and that are from among adjacent blocks of the current block, and a time direction motion vector of a corresponding region included in a reference frame having a different view from the current block and the same POC as the current frame. As described above, the time direction motion vector predictor candidates may include a first time direction motion vector predictor that is selected from among time direction motion vectors that are adjacent to a left side of the current block referring to a reference frame having the first view, a second time direction motion vector predictor that is selected from among time direction motion vectors that are adjacent to an upper side of the current block, and a third time direction that is selected from among time direction motion vectors of blocks that are adjacent to vertexes of the current block and are encoded before the current block. The time direction motion vector predictor candidates may further include a median value of the first time direction motion vector predictor, the second time direction motion vector predictor, and the third time direction motion vector predictor. In addition, the time direction motion vector predictor candidates may include a time direction motion vector of a corresponding block obtained by shifting a co-located block of the current block, which is included in the second reference frame, by using a view direction motion vector of adjacent blocks of the current block.

In operation 930, the motion vector encoding unit 330 encodes a difference value between a time direction motion vector of the current block and a time direction motion vector predictor selected from among time direction motion vector predictor candidates, and mode information about the selected time direction motion vector predictor.

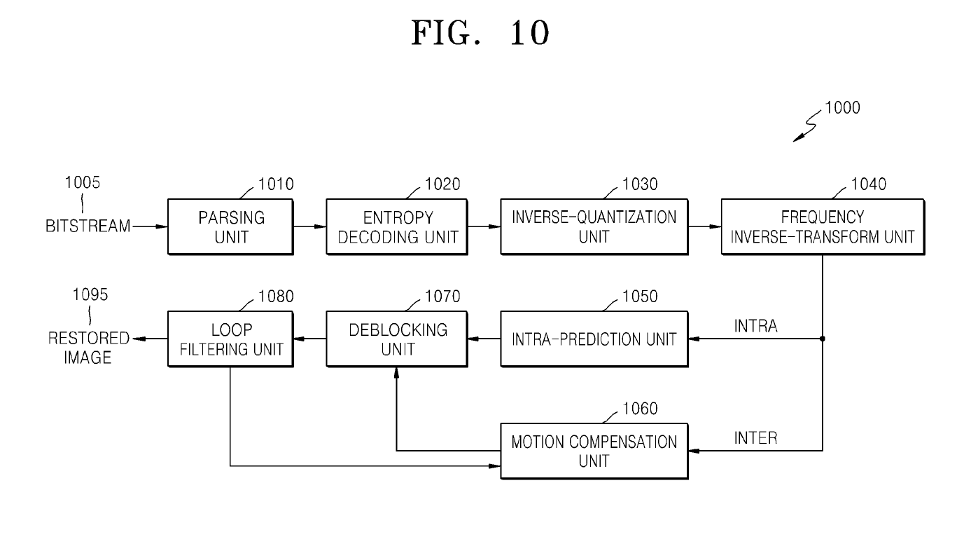

FIG. 10 is a block diagram of a multi-view video encoding apparatus 1000 according to an exemplary embodiment.

Referring to FIG. 10, the multi-view video encoding apparatus 1000 includes a parsing unit 1010, an entropy decoding unit 1020, an inverse-quantization unit 1030, a frequency inverse-transform unit 1040, an intra-prediction unit 1050, a motion compensation unit 1060, a deblocking unit 1070, and a loop filtering unit 1080.

While a bitstream 1005 passes through the parsing unit 1010, encoded multi-view image data to be decoded and information used for decoding are parsed. The encoded multi-view image data is output as inverse-quantized data by the entropy decoding unit 1020 and the inverse-quantization unit 1030, and image data in a spatial domain is restored by the frequency inverse-transform unit 1040.

With respect to the image data in the spatial domain, the intra-prediction unit 1050 performs intra-prediction on an intra-mode block, and the motion compensation unit 1060 performs motion compensation on an inter-mode block by using a reference frame. In particular, in a case where prediction mode information of a current block to be decoded indicates a view direction skip mode, the motion compensation unit 1060 according to the present exemplary embodiment generates a motion vector predictor of the current block by using motion vector information of the current block, wherein the motion vector information is read from a bitstream, restores a motion vector of the current block by adding a difference value and a motion vector predictor which are included in the bitstream, and performs motion compensation by using the restored motion vector. As described above, when the current block is view direction prediction-encoded, the motion compensation unit 1060 selects a view direction motion vector predictor from among view direction motion vector predictor candidates that are generated by using view direction motion vectors of an adjacent block that refers to a reference frame having a different view from the first view of the current block and that is from among adjacent blocks of the current block, and a view direction motion vector of a corresponding region included in a second reference frame having a first view that is the same as the current block and a different POC from the current frame, according to index information contained in information about a motion vector predictor. In addition, when the current block is time direction prediction-encoded, the motion compensation unit 1060 selects a time direction motion vector predictor from among time direction motion vector predictor candidates that are generated by using time direction motion vectors of an adjacent block that refers to a reference frame having a first view and that is from among adjacent blocks of the current block, and a time direction motion vector of a corresponding region included in a second frame having the same POC as the current frame and a second view that is different from the current block, according to index information contained in information about a motion vector predictor. A process of generating a time direction motion vector predictor and a view direction motion vector predictor in the motion compensation unit 1060 is the same as or similar to a process performed in the motion prediction unit 220 of FIG. 2, and thus a detailed description of the process is omitted herein.

The image data in the spatial domain transmitted through the intra-prediction unit 1050 and the motion compensation unit 1060 is post-processed by the deblocking unit 1070 and the loop filtering unit 1080 and then is a restoration frame 1085.

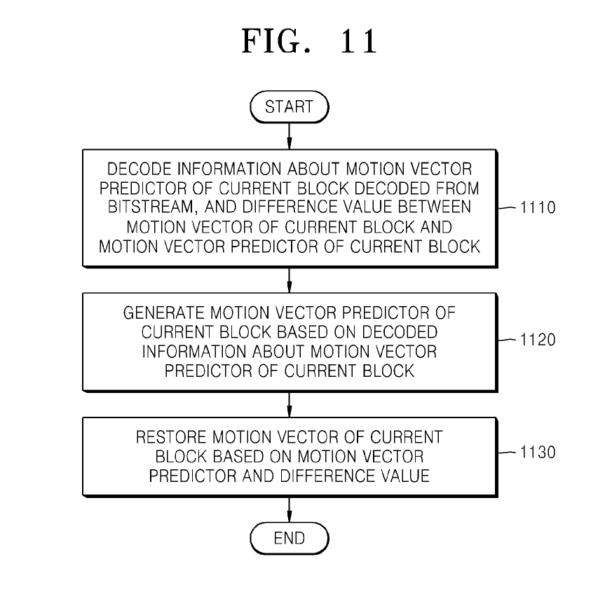

FIG. 11 is a flowchart of a method of decoding a video, according to an exemplary embodiment.

In operation 1110, information about a motion vector predictor of a current block decoded from a bitstream, and a difference value between a motion vector of the current block and a motion vector predictor of the current block are decoded.

In operation 1120, a motion vector predictor of the current block is generated based on the decoded information about the motion vector predictor of the current block. As described above, a motion vector predictor may be selected from view direction motion vector predictor candidates that are generated by using view direction motion vectors of an adjacent block that refers to a reference frame having a different view from a first view of the current block and that is from among adjacent blocks of the current block, and a view direction motion vector of a corresponding region included in a second reference frame having a first view that is the same as the current block and a different POC as a current frame, according to index information contained in information about the motion vector predictor. In addition, the motion vector predictor may be selected from among time direction motion vector predictor candidates that are generated by using time direction motion vectors of an adjacent block that refers to a reference frame having the first view and that is from among adjacent blocks of the current block, and a time direction motion vector of a corresponding region included in the second reference frame having a second view different from the current block and the same POC as the current frame, according to index information contained in information about the motion vector predictor.

In operation 1130, a motion vector of the current block is restored based on the motion vector predictor and the difference value. When the motion vector of the current block is restored, the motion compensation unit 1060 generates a prediction block of the current block through motion compensation, and restores the current block by adding the generated prediction block and a residual value that is read from a bitstream.

Exemplary embodiments can also be embodied as computer-readable codes on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, etc. The computer-readable recording medium can also be distributed over network-coupled computer systems so that the computer-readable code is stored and executed in a distributed fashion. Moreover, one or more of the above-described units can include a processor or microprocessor executing a computer program stored in a computer-readable medium.

While exemplary embodiments have been particularly shown and described above, it will be understood by those of ordinary skill in the art that various changes in form and details may be made therein without departing from the spirit and scope of the present invention as defined by the following claims.

What is claimed is:

1. A method of encoding a motion vector of a multi-view video, the method comprising:
determining a view direction motion vector of a current block to be encoded by performing motion prediction on the current block with reference to a first frame having a second view that is different from a first view of the current block;
determining view direction motion vector predictor candidates using a view direction motion vector of an adjacent block that refers to a reference frame having a different view from the first view and that is from among adjacent blocks of the current block, and a view direction motion vector of a corresponding region included in a second reference frame having the first view and a different picture order count (POC) than the current frame; and
encoding a difference value between the determined view direction motion vector of the current block and a view direction motion vector predictor selected from among the determined view direction motion vector predictor candidates, and mode information about the selected view direction motion vector predictor.

2. The method of claim 1, wherein the determined view direction motion vector predictor candidates comprise:
a first view direction motion vector predictor that is selected from among view direction motion vectors of blocks that are adjacent to a left side of the current block referring to a reference frame having a different view from the first view;
a second view direction motion vector predictor that is selected from among view direction motion vectors of blocks that are adjacent to an upper side of the current block; and
a third view direction motion vector predictor that is selected from among view direction motion vectors of blocks that are adjacent to corners of the current block and are encoded before the current block.

3. The method of claim 2, wherein the determined view direction motion vector predictor candidates further comprise a median value of the first view direction motion vector predictor, the second view direction motion vector predictor, and the third view direction motion vector predictor.

4. The method of claim 3, wherein, in order to determine the median value, a motion vector predictor that does not correspond to any of the first view direction motion vector predictor, the second view direction motion vector predictor, and the third view direction motion vector predictor, is set as a 0 vector.

5. The method of claim 1, wherein the determined view direction motion vector predictor candidates comprise a view direction motion vector of a corresponding block obtained by shifting a co-located block of the current block, which is included in the second reference frame, by using a time direction motion vector of an adjacent block of the current block.

6. The method of claim 5, wherein the co-located block of the current block is shifted by a median value of time direction motion vectors of adjacent blocks of the current block.

7. The method of claim 1, wherein the determined view direction motion vector predictor candidates comprise a view direction motion vector of a corresponding region obtained by shifting a co-located block of the current block, which is included in the second reference frame, by using a time direction motion vector of a co-located block included in a third reference frame having a same POC as a current frame including the current block and a different view from the first view.

8. The method of claim 1, wherein the encoding the mode information about the view direction motion vector predictor comprises differentiating the determined view direction motion vector predictor candidates according to indexes, and encoding index information corresponding to the selected view direction motion vector predictor that is used to predict the view direction motion vector of the current block.

9. A method of encoding a motion vector of a multi-view video, the method comprising:
determining a time direction motion vector of a current block to be encoded by performing motion prediction on the current block with reference to a first frame having a first view that is a same as a view of the current block;
determining time direction motion vector predictor candidates using a time direction motion vector of an adjacent block that refers to a reference frame having the first view and that is from among adjacent blocks of the current block, and a time direction motion vector of a corresponding region included in a second reference frame having a different view from the current block and a same POC as the current block; and
encoding a difference value between the time direction motion vector of the current block and a time direction motion vector predictor selected from among the determined time direction motion vector predictor candidates, and mode information about the selected time direction motion vector predictor.

10. The method of claim 9, wherein the determined time direction motion vector predictor candidates comprise:
a first time direction motion vector predictor selected from time direction motion vectors of blocks that are adjacent to a left side of the current block referring to the reference frame having the first view;
a second time direction motion vector predictor selected from among time direction motion vectors of blocks that are adjacent to an upper side of the current block; and
a third time direction motion vector predictor selected from among time direction motion vectors of bocks that are adjacent to corners of the current block and are encoded before the current block.

11. The method of claim 10, wherein the determined time direction motion vector predictor candidates further comprise a median value of the first time direction motion vector predictor, the second time direction motion vector predictor, and the third time direction motion vector predictor.

12. The method of claim 11, wherein, in order to determine the median value, a motion vector predictor that does not correspond to any of the first time direction motion vector predictor, the second time direction motion vector predictor, and the third time direction motion vector predictor, is set as a 0 vector.

13. The method of claim 10, wherein the first time direction motion vector predictor, the second time direction motion vector predictor, and the third time direction motion vector predictor are motion vectors of an adjacent block that is identified according to a predetermined scanning order, from among motion vectors of adjacent blocks referring to the first reference frame.

14. The method of claim 10, wherein, when there is no motion vector of the adjacent block referring to the first reference frame, the first time direction motion vector predictor, the second time direction motion vector predictor, and the third time direction motion vector predictor are determined by scaling a time direction motion vector of an adjacent block referring to a different reference frame from the first reference frame.

15. The method of claim 9, wherein the determined time direction motion vector predictor candidates comprises a time direction motion vector of a corresponding region obtained by shifting a co-located block of the current block, which is included in the second reference frame, by using a view direction motion vector of an adjacent block of the current block.

16. The method of claim 15, wherein the co-located block of the current block is shifted by a median value of view direction motion vectors of adjacent blocks of the current block.

17. The method of claim 9, wherein the determined time direction motion vector predictor candidates comprise a time direction motion vector of a corresponding region obtained by shifting a co-located block of the current block, which is included in the second reference frame, by using a view direction motion vector of a co-located block included in a third reference frame having the first view and a different POC from the current block.

18. The method of claim 9, wherein the encoding the mode information about the time direction motion vector predictor comprises differentiating the time direction motion vector predictor candidates according to indexes, and encoding index information corresponding to the selected time direction motion vector predictor that is used to predict the time direction motion vector of the current block.

19. A method of decoding a motion vector of a multi-view video, the method comprising:
decoding information about a motion vector predictor of a current block, and a difference value between a motion vector of the current block and the motion vector predictor of the current block;
determining the motion vector predictor of the current block based on the decoded information about the motion vector predictor of the current block; and
restoring the motion vector of the current bock based on the determined motion vector predictor and the decoded difference value,
wherein the motion vector predictor is selected from among view direction motion vector predictor candidates that are determined using a view direction motion vector of an adjacent block that refers to a reference frame having a different view from the first view and that is from among adjacent blocks of the current block, and a view direction motion vector of a corresponding region included in a second reference frame having the first view and a different picture order count (POC) than the current frame, according to index information comprised in the information about the motion vector predictor.

20. The method of claim 19, wherein the determined view direction motion vector predictor candidates comprise:
a first view direction motion vector predictor that is selected from among view direction motion vectors of blocks that are adjacent to a left side of the current block referring to a reference frame having a different view from the first view;
a second view direction motion vector predictor that is selected from among view direction motion vectors of blocks that are adjacent to an upper side of the current block; and
a third view direction motion vector predictor that is selected from among view direction motion vectors of blocks that are adjacent to corners of the current block and are encoded before the current block.

21. The method of claim 20, wherein the determined view direction motion vector predictor candidates further comprise a median value of the first view direction motion vector predictor, the second view direction motion vector predictor, and the third view direction motion vector predictor.

22. The method of claim 19, wherein the determined view direction motion vector predictor candidates comprise a view direction motion vector of a corresponding block obtained by shifting a co-located block of the current block, which is included in the second reference frame, by using a time direction motion vector of an adjacent block of the current block.

23. The method of claim 22, wherein the co-located block of the current block is shifted by a median value of time direction motion vectors of adjacent blocks of the current block.

24. The method of claim 19, wherein the determined view direction motion vector predictor candidates comprise a view direction motion vector of a corresponding region obtained by shifting a co-located block of the current block, which is included in the second reference frame, by using a time direction motion vector of a co-located block included in a third reference frame having a same POC as a current frame including the current block and a different view from the first view.

25. A method of decoding a motion vector of a multi-view video, the method comprising:
decoding information about a motion vector predictor of a current block, and a difference value between the motion vector of the current block and the motion vector predictor of the current block;
determining the motion vector predictor of the current block based on the decoded information about the motion vector predictor of the current block; and
restoring the motion vector of the current bock based on the determined motion vector predictor and the decoded difference value,
wherein the motion vector predictor is selected from among time direction motion vector predictor candidates that are determined by using a time direction motion vector of an adjacent block that refers to a reference frame having the first view and that is from among adjacent blocks of the current block, and a time direction motion vector of a corresponding region included in a second reference frame having a different view from the current block and a same POC as the current block, according to index information comprised in the information about the motion vector predictor.

26. The method of claim 25, wherein the determined time direction motion vector predictor candidates comprise:
a first time direction motion vector predictor selected from time direction motion vectors of blocks that are adjacent to a left side of the current block referring to the reference frame having the first view;
a second time direction motion vector predictor selected from among time direction motion vectors of blocks that are adjacent to an upper side of the current block; and
a third time direction motion vector predictor selected from among time direction motion vectors of bocks that are adjacent to corners of the current block and are encoded before the current block.

27. The method of claim 26, wherein the determined time direction motion vector predictor candidates further comprise a median value of the first time direction motion vector predictor, the second time direction motion vector predictor, and the third time direction motion vector predictor.

28. The method of claim 27, wherein, in order to determine the median value, a motion vector predictor that does not correspond to any of the first time direction motion vector predictor, the second time direction motion vector predictor, and the third time direction motion vector predictor, is set as a 0 vector.

29. The method of claim 26, wherein the first time direction motion vector predictor, the second time direction motion vector predictor, and the third time direction motion vector predictor are motion vectors of an adjacent block that is identified according to a predetermined scanning order, from among motion vectors of adjacent blocks referring to the first reference frame.

30. The method of claim 25, wherein, when there is no motion vector of the adjacent block referring to the first reference frame, the first time direction motion vector predictor, the second time direction motion vector predictor, and the third time direction motion vector predictor are determined by scaling a time direction motion vector of an adjacent block referring to a different reference frame from the first reference frame.

31. The method of claim 25, wherein the determined time direction motion vector predictor candidates comprise a time direction motion vector of a corresponding region obtained by shifting a co-located block of the current block, which is included in the second reference frame, by using a view direction motion vector of an adjacent block of the current block.

32. The method of claim 31, wherein the co-located block of the current block is shifted by a median value of view direction motion vectors of adjacent blocks of the current block.

33. The method of claim 25, wherein the time direction motion vector predictor candidates comprise a time direction motion vector of a corresponding region obtained by shifting a co-located block of the current block, which is included in the second reference frame, by using a view direction motion vector of a co-located block included in a third reference frame having the first view and a different POC from the current block.

34. An apparatus for encoding a motion vector of a multi-view video, the apparatus comprising:
a view direction motion prediction unit which determines a view direction motion vector of a current block to be encoded by performing motion prediction on the current block with reference to a first frame having a second view that is different from a first view of the current block;
a motion vector encoding unit which determines view direction motion vector predictor candidates by using a view direction motion vector of an adjacent block that refers to a reference frame having a different view from the first view and that is from among adjacent blocks of the current block, and a view direction motion vector of a corresponding region included in a second reference frame having the first view and a different picture order count (POC) than the current frame, and which encodes a difference value between the determined view direction motion vector of the current block and a view direction motion vector predictor selected from among the determined view direction motion vector predictor candidates, and mode information about the selected view direction motion vector predictor.

35. An apparatus for encoding a motion vector of a multi-view video, the apparatus comprising:
a time direction motion prediction unit which determines a time direction motion vector of a current block to be encoded by performing motion prediction on the current block with reference to a first frame having a first view that is a same view as the current block; and
a motion vector encoding unit which determines time direction motion vector predictor candidates by using a time direction motion vector of an adjacent block that refers to a reference frame having the first view and that is from among adjacent blocks of the current block, and a time direction motion vector of a corresponding region included in a second reference frame having a different view from the current block and a same POC as the current block, and which encodes a difference value between the time direction motion vector of the current block and a time direction motion vector predictor selected from among the determined time direction motion vector predictor candidates, and mode information about the selected time direction motion vector predictor.

36. An apparatus for decoding a motion vector of a multi-view video, the apparatus comprising:
a motion vector decoding unit which decodes information about a motion vector predictor of a current block, and a difference value between the motion vector of the current block and the motion vector predictor of the current block;
a motion compensation unit which determines the motion vector predictor of the current block based on the decoded information about the motion vector predictor of the current block, and which restores the motion vector of the current bock based on the determined motion vector predictor and the decoded difference value,
wherein the motion vector predictor is selected from among view direction motion vector predictor candidates that are determined using a view direction motion vector of an adjacent block that refers to a reference frame having a different view from the first view and that is from among adjacent blocks of the current block, and a view direction motion vector of a corresponding region included in a second reference frame having the first view that is a same view as the current block and a different picture order count (POC) of the current frame, according to index information comprised in the information about the motion vector predictor.

37. An apparatus for decoding a motion vector of a multi-view video, the apparatus comprising:
a motion vector decoding unit which decodes information about a motion vector predictor of a current block, and a difference value between the motion vector of the current block and the motion vector predictor of the current block; and
a motion compensation unit which determines the motion vector predictor of the current block based on the decoded information about the motion vector predictor of the current block, and restores the motion vector of the current bock based on the determined motion vector predictor and the decoded difference value,
wherein the motion vector predictor is selected from among time direction motion vector predictor candidates that are determined using a time direction motion vector of an adjacent block that refers to a reference frame having the first view and that is from among adjacent blocks of the current block, and a time direction motion vector of a corresponding region included in a second reference frame having a different view from the current block and a same POC as the current block, according to index information comprised in the information about the motion vector predictor.

38. A computer readable recording medium having recorded thereon a program executable by a computer for performing the method of claim 1.

39. A computer readable recording medium having recorded thereon a program executable by a computer for performing the method of claim 9.

40. A computer readable recording medium having recorded thereon a program executable by a computer for performing the method of claim 19.

41. A computer readable recording medium having recorded thereon a program executable by a computer for performing the method of claim 25.
